(19) United States
(12) Patent Application Publication
(10) Pub. No.: US 2023/0342612 A1
(43) Pub. Date: Oct. 26, 2023

(54) USING HEADER MATRICES FOR FEATURE IMPORTANCE ANALYSIS IN MACHINE LEARNING MODELS

(71) Applicant: Dell Products L.P., Round Rock, TX (US)

(72) Inventors: Jaumir Valença da Silveira Junior, Rio de Janeiro (BR); Eduardo Vera Sousa, Niteroi/RJ (BR); Vinicius Michel Gottin, Rio de Janeiro (BR)

(21) Appl. No.: 17/660,144

(22) Filed: Apr. 21, 2022

(51) Int. Cl. G06N 3/08; G06F 17/16

(52) U.S. Cl. CPC G06N 3/084; G06F 17/16

(57) ABSTRACT

A header matrix prepended to a machine learning model allows the relative importance of a dataset's features to be determined or inferred. The header matrix begins as an Identity matrix. Gradients associated with a backpropagation are stored in the header matrix and accumulated in an accumulation matrix. The relative importance of each feature of the dataset can be determined or inferred from the accumulation matrix.

### FIELD OF THE INVENTION

Embodiments of the present invention generally relate to machine learning and machine learning models. More particularly, at least some embodiments of the invention relate to systems, hardware, software, computer-readable media, and methods for understanding and identifying the relative importance of features (covariates) in machine learning (ML) models.

### BACKGROUND

Machine learning models such as artificial neural networks (ANN) are often configured to generate an inference based on a set of inputs. The set of inputs includes include features or covariates. For example, when predicting or generating an inference regarding the type of pet a person may select, the features may include age, income, location, or the like.

Machine learning models, however, can be complex and may use many different features. In some examples, the complexity of the machine learning model can be reduced by removing one or more of the features. The difficulty, however, is understanding which features are the most/least important to the accuracy of the machine learning model.

Attempts have been made to determine the relative importance of features in machine learning models. Some methods use model weights or operations with the weights to gauge the importance of features. Other methods use statistical tools and the variation of data according to specific circumstances to relate the features to the outputs of trained machine learning models. Other methods use model weights or operations along with statistical tools to gauge the feature importance with trained machine learning models. These methods, however, require selected data to be extensively pre-processed and/or require extensive computational resources.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of determining relative importance of features using a header matrix appended to a machine learning model;

FIG. 2A discloses aspects of a plot for dataset features;

FIG. 2B discloses aspects of pairwise correlations between features of a dataset;

FIG. 3 discloses aspects of accuracies associated with a model that reflect the relative importance of the features;

FIG. 4A discloses aspects of using a header matrix to determine the relative importance of features of a synthetic data set where the relative importance is known in advance;

FIG. 4B discloses aspects of using a header matrix to determine the relative importance of features of a synthetic data set where the relative importance is known in advance;

FIG. 5 discloses aspects of determining or inferring the relative importance of a dataset's features;

FIG. 6 discloses aspects of an accumulation matrix used in determining or inferring the relative importance of a dataset's features; and

FIG. 7 discloses aspects of a computing device, system, entity, or environment.

### DETAILED DESCRIPTION OF SOME EXAMPLE EMBODIMENTS

Embodiments of the present invention generally relate to machine learning models. More particularly, at least some embodiments of the invention relate to systems, hardware, software, computer-readable media, and methods for determining the relative importance of features in machine learning and which are input to machine learning models.

Understanding the importance of features (covariates) in machine learning has many advantages. For example, principal component analysis (PCA) is a method used to reduce the dimensionality of large data sets by transforming a large set of variables into a smaller set of variables that contains, for the most part, the same information. Embodiments of the invention identify the relative importance of features to facilitate dimensionality reduction.

Embodiments of the invention estimate the relative importance of features within a machine learning model (e.g., an artificial neural network (ANN) such as a multi-layer perceptron (MLP)) while accounting for input set distribution P(X) and outcome distribution P(Y|X), where X is the input set and Y is the set of possible outcomes in a space. Embodiments of the invention may also consider changes in these distributions over time.

A header matrix may be an Identity matrix that is prepended to a machine learning model and becomes part of the first layer of the machine learning model. In one example, an identity matrix is a square matrix wherein the main diagonal is comprised only of “1”s and the other elements are only zeros. The number of columns is the same as the number of rows. The header matrix is configured to collect variations (e.g., gradients) related to each feature or variable during a backpropagation phase of training epochs. This allows the relative importance of the features to be inferred or estimated. In one example, the gradients can be accumulated over multiple epochs using an accumulation matrix and the relative features can be inferred from the accumulation matrix.

Being able to determine how feature importance dynamically varies in time can be useful in the mechanism of machine learning model drift detection/correction, for example. Regardless of which model drift detection is used, once a “drift” is identified, “feature importance” can be used to assess the drift severity and help decision making. For example, if a model drift occurred due to changes of distribution of the least relevant features in the input data set, drift correction may not be advisable.

Moreover, determining feature importance is useful in homogeneous edge environments. More specifically, determining feature importance is useful when machine learning models are deployed in an ensemble of edge nodes where both input sets distribution P(X) and outcome distribution P(Y|X) are expected to be the same.

For example, once a model drift is detected on a single edge, a decision can be made based on feature importance. This may determine whether the machine learning model needs to be re-trained and re-deployed in all of the nodes. If different edges start to drift with different patterns of feature importance, this may signal that the homogeneity of the edge environment is breaking down. For instance, if a node “k” starts to constantly detect drifts caused by the least important calculated feature, that may indicate that this node “k” should be detached from the ensemble and that a new ensemble should be started. Stated differently, this may indicate that the least important feature is not the least important feature for the node “k”.

The header matrix used to collect gradients is an Identity matrix because an Identity matrix does not change the input dataset during forward propagation of an ANN, as follows: When an input matrix having dimensions (1, n) is multiplied by a header matrix of dimensions (n, n) the outcome is a matrix of dimensions (1, n). The output has the same dimension as the input matrix. In fact, the output is identical to the input. This also applies to an input matrix having dimensions of (k, n). The matrix multiplication of (k, n)*(n, n) generates an output matrix of the form (k, n). In this multiplication, each time a row of the matrix (k, n) is multiplied by a column of the matrix (n, n), the first element of the row is multiplied by the first element of the column, the second element of the row is multiplied by the second element of the column, and so forth. Consequently, the first row of the matrix (n, n) influences the first column of the input matrix (k, n), the second row of matrix (n, n) influences the second column of the input matrix (k, n), and so forth. This allows each of the features, which are represented in the rows of the input matrix, to be evaluated in terms of relative importance as discussed in more detail herein.

In one example, a header matrix of order (n,n) is added to a machine learning model (e.g., an MLP model) whose input matrix has the dimensions (k, n). In this example, k is the number of samples and n is the number of features. The header matrix is inserted or added as the first layer of the MLP model. Because the header matrix is an Identity matrix and not part of the original MLP model, there is no need to apply a non-linearization to the output of the header matrix during the forward propagation.

The header matrix participates normally in the training process in both the forward and back propagations. However, the header matrix is typically reset before each forward propagation of each training epoch in one embodiment. Resetting the header matrix includes reverting the header matrix to an Identity matrix. Before resetting the header matrix, the adjusted weights, after the header matrix goes through backpropagation, are accumulated epoch by epoch in an accumulation matrix with the same order as the header matrix. Backpropagation determines, in one example, gradients of the loss function with respect to the weights of the MLP model, which may be a neural network.

After the MLP model is trained, each row of the accumulation matrix contains information about a corresponding feature of the input set. This allows the relative importance of the features to be determined or inferred. Embodiments of the invention may be used, by way of example, with machine learning models that perform classification, where each feature (e.g., column in an input matrix) has semantic meaning of itself. This is distinct, for example, from convolutional neural networks for images, where each input element does not convey a meaningful interpretation of the image itself.

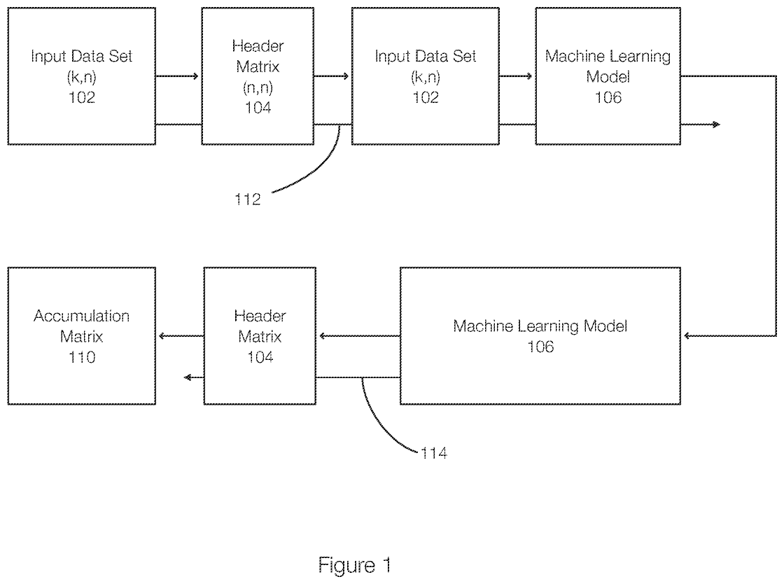

FIG. 1 discloses aspects of training a machine learning model that includes or is associated with a header matrix. FIG. 1 illustrates a machine learning model 106 during forward propagation 112 and during back propagation 114. In this example, an input data set 102 (k, n) is input to a header matrix 104 (n, n). The output of the header matrix 104 is the input data set 102. Because the header matrix 104 is an Identity matrix, the input data set 102 is unchanged. As a result, the header matrix 104 does not influence the operation of the machine learning model 106.

During back propagation 114, the back propagated gradients reach the first layer of the machine learning model 106 and then the backpropagation continues through the header matrix, such the back propagated gradients are stored in the header matrix 104

Once the back propagated gradients or other information are present in the header matrix 104, the gradients are added to the accumulation matrix 110. More specifically, the data added to the accumulation matrix 110 is the difference between the header matrix 104 after the back propagation 114 and the Identity matrix 104 prior to the forward propagation 112.

After each epoch, the header matrix 104 is reset to the Identity matrix and another epoch may be performed. In on example, an epoch is a complete pass of the training dataset through the machine learning model 106. Thus, a complete pass of the input data set 102 (forwards and backwards) is an example of an epoch. The header matrix 104 is reset after each epoch in one embodiment.

The header matrix 104 and the accumulation matrix 110 allow the most/least important features of the input data set 102 to be identified or inferred. The following discussion demonstrates the effectiveness of the header matrix and/or accumulation matrix based on a standard baseline dataset and based on synthetic datasets. In the synthetic datasets, the relative importance of the features is known a priori. This allows the operation of the header matrix in identifying or inferring the relative importance of features to be identified.

Conventionally, feature importance classification methods demonstrated different results for well-known test datasets, such as the Iris Dataset. This may be attributed to the probabilistic nature of datasets and techniques. The benefit of synthetic datasets, for demonstration purposes, is that the relative feature importance is established and known in advance.

The Iris dataset (see https://onlinelibrary.wiley.com/doi/epdf/10.1111/j.1469-1809.1936.tb02137.x) is often used in the context of pattern recognition. The dataset includes 3 classes of 50 instances for each class. Each class refers to a type of Iris plant. Once class is linearly separately from the other 2 classes. The latter 2 classes are not linearly separable from each other.

The attribute information (features) are identified as follows:
1. sepal length in centimeters (cm)
2. sepal width in cm
3. petal length in cm
4. petal width in cm
5. class: {Iris setosa, Iris versicolour, Iris virginica}

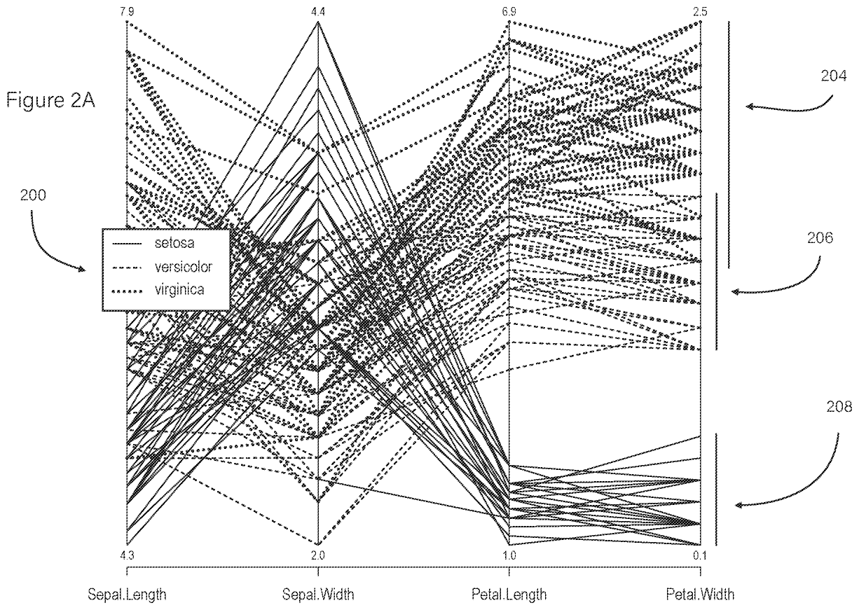

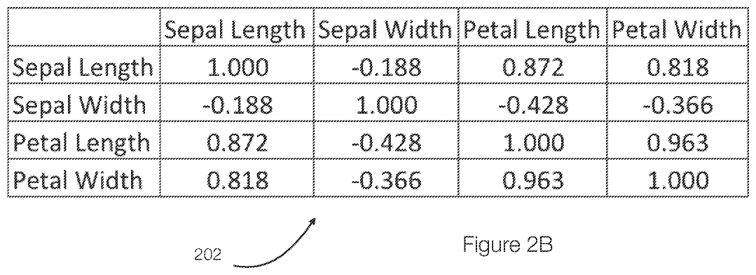

FIG. 2A illustrates a parallel coordinate plot for the Iris dataset. The plot 200 demonstrates that petal length and petal width appear to clearly separate for the three classes. At the same time, sepal length and sepal width do not clearly separate. The plot lines for the class virginica are generally at line 204, the plot for the class versicolor are generally at line 206, and the plot for the class setosa are generally at line 208 (a color version is provided in the appendix). As illustrated, the vertical lines 204, 206, and 208 illustrate how the three classes are separated with respect to petal width. Following the lines demonstrates that sepal length and sepal width are not as separated. With respect to petal width, there is some overlap between the class virginica (204) and the class versicolor (206).

FIG. 2B illustrates a pairwise correlation between the features of the Iris dataset. The table 202 illustrates that the sepal width feature has a negative correlation to the other features. This may yield the conjecture that the sepal width may be the least decisive feature for the model classification. Considering the plot 200 of FIG. 2A and the table 202 of FIG. 2B may suggest that the relative feature importance is as follows:
Most decisive features: Petal Width and Petal Length
Leas decisive features: Sepal Width

More specifically, the plot 200 illustrates that the features of petal length and petal width are most clearly separated and the table 202 illustrates that the pairwise correlation between petal width and petal length is the highest (0.963).

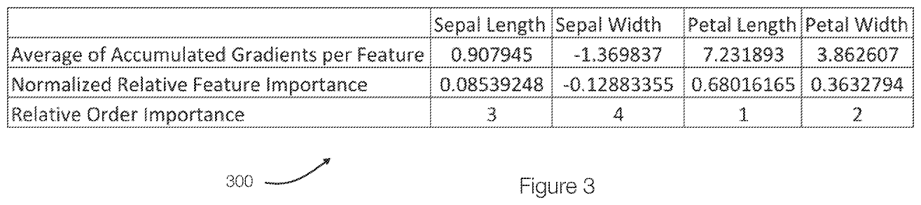

FIG. 3 represents results associated when the machine learning model includes a header matrix. In FIG. 3, the model was similarly trained 20 times and an accumulator matrix was used to collect the gradients generated during the back propagation. The table 300 illustrates the average of the accumulated gradients per feature, the normalized relative feature importance, and the relative order importance. As illustrated in the table 300, the relative feature importance, in descending order, 1 petal length, 2 petal width, 3 sepal length, and 4 sepal width. These results are in consonance with the parallel coordinate plot 200 illustrated in FIG. 2A.

Next, the header matrix and the accumulation matrix are used in the context of synthetic datasets where the relative importance of each feature in relation to the model is known in advance.

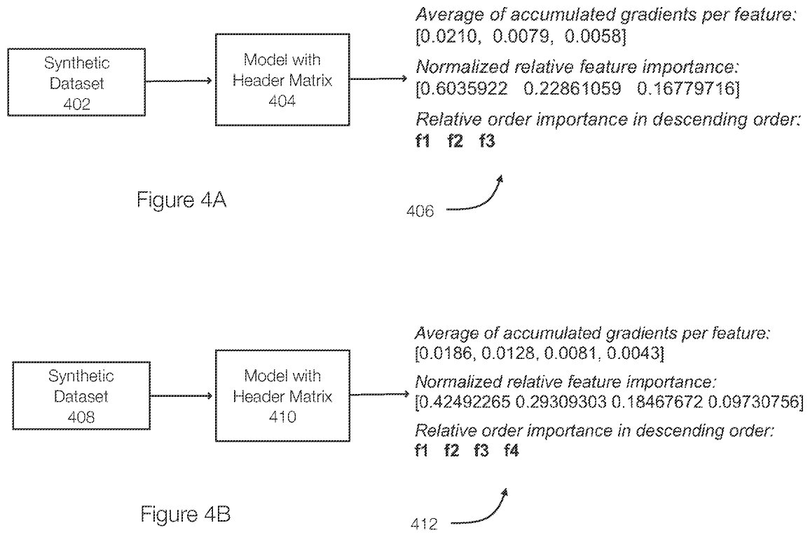

FIG. 4A illustrates the relative feature importance order of a model trained using a synthetic data set. In FIG. 4A the synthetic dataset 402 is input to a model 404 with a header matrix. The synthetic dataset 402, in this example, is 3 feature 3 class synthetic dataset.

This dataset can be described as follows (the relative importance of the features is known in advance):
Features: 3 features (f1, f2, f3)
Number of output classes: 3
Number of samples 300.000
Importance of f1: 0.49917220697159603
Importance of f2: 0.30118183790786557
Importance of f3: 0.19964495512053845
Row example:
f1, f2, f3, target

In one example, multiple runs or epochs were performed using the synthetic dataset 402. The table 406 illustrates an average of the accumulated gradients, the normalized relative feature importance, and the relative order importance in descending order. The relative feature importance given by the header matrix matches the expected relative importance of the features in the synthetic dataset.

FIG. 4B illustrates the relative feature importance order of a model trained using another synthetic dataset. The example of FIG. 4B inputs the synthetic dataset 408 to a model 410 with a header matrix. Prior to reach run or epoch, the header matrix is reset. The synthetic dataset 408, in this example, is 4 feature 3 class synthetic dataset.

This dataset 408 can be described as follows:
Features: 4 features: f1, f2, f3 and f4
Number of output classes: 3
Number of samples: 300.000
Importance of f1: 0.39982890305357477
Importance of f2: 0.29898009965864
Importance of f3: 0.1992222406684163
Importance of f4: 0.10196875661936884

In one example, multiple runs or epochs were performed using the synthetic dataset 408. The table 412 illustrates an average of the accumulated gradients, the normalized relative feature importance, and the relative order importance in descending order. The relative feature importance given by the header matrix of the model 410 matches the expected relative importance of the features in the synthetic dataset 408. Similar results were obtained with a 5 feature 3 class synthetic dataset wherein the header matrix was able to infer or determine an order of relative importance of the features that matched the order of feature importance known in advance.

Embodiments of the invention provide advantages from both a space perspective and a computational perspective. With regard to space or memory requirements, embodiments of the invention require storage for two (n×n) matrices where n is the number of input features. One matrix is the header matrix, and the other matrix is the accumulator matrix. With regard to computational complexity, the complexity is O(N), where N is the number of epochs the model training requires. For each epoch, there is:
one attribution operation where the header matrix is reset to the (n×n) identity matrix Identity matrix;
one sum of two (n×n) matrices, corresponding to the accumulation step performed at the end of each full backpropagation; and
one subtraction of two (n×n) matrices, corresponding to removing the identity values introduced by the header matrix and the beginning of each forward propagation.

Embodiments of the invention can determine the relative feature importance at the time of training the model and while using two extra matrices. In one example, a header matrix is prepended to a machine learning model (e.g., a classification ANN) in order to determine the relative importance of each input feature in relation to the model output values, given an input training set.

The relative importance of features can be used for many model-management tasks, such as for feature selection. for providing introspection (or even some level of explainability) into a machine learning model, for dimensionality reduction, and for many tasks related to drift detection. For example, feature importance can be used for the determination of the necessity of re-training and re-deployment of models under concept drift, or for the identification of drift itself.

In one example, the header matrix is assigned the weights of the first ML model layer and this layer, in one example, is a linear neural layer. The header matrix includes or is an Identity matrix in one example.

More specifically, the header matrix includes an identity matrix of order (n×n), where n is the number of features of a training input dataset to a classification machine learning model. The header matrix participates normally in the training process and in both the forward and back propagations. However, the weights of the header matrix are reset before each forward propagation of each training epoch. After each backpropagation phase and before the header matrix is reset, the adjusted weights are accumulated epoch by epoch in an accumulation matrix having the same order as the header matrix.

The sum (or average of the sum) of the values of each row of the accumulation matrix determines the relative importance of each input feature. More specifically, the sum of the values of the first row indicates the relative importance of the first input feature, the sum of the values of the second row indicates the relative importance of the second input feature, and so on.

Thus, if the sum of the values of the first row is bigger than the sum of the values of the second row in the accumulation matrix, the first feature in the input set is more important than the second feature in the input set.

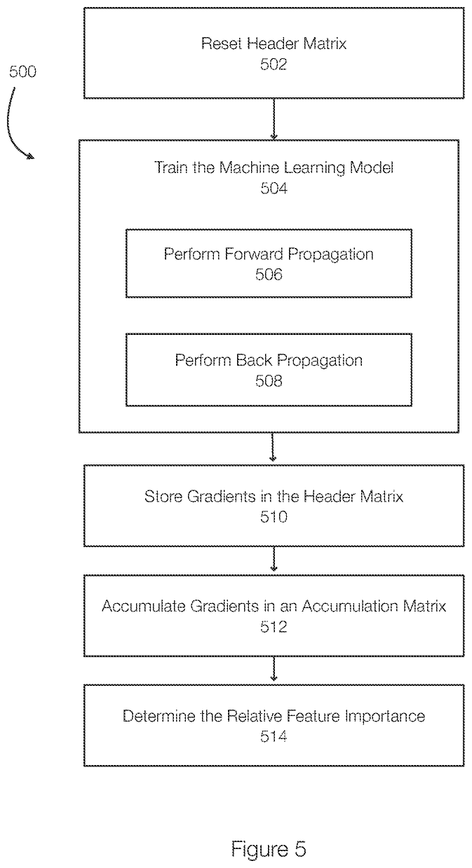

FIG. 5 discloses aspects of determining the relative feature importance of the features of an arbitrary input set used to train a machine learning model. The method 500 begins by resetting 502 a header matrix associated with a machine learning model.

In one example, the header matrix may not need to be reset if this is the initial run. Rather, the header matrix is generally reset after an epoch or after running a data set. Resetting 502 the header matrix may include ensuring that the header matrix is prepared for use, such as training the machine learning model with the purpose of determining the relative importance of the features of the input dataset.

Next, the machine learning model is trained 504 with an input data set. Training 504 the machine learning model may include performing 506 a forward propagation and performing a back propagation 508. Inputting a dataset into a machine learning model may include inputting a dataset where each data item (record) includes features (covariates).

The back propagation 508 generates gradient updates that are backpropagated from the last layer of the machine learning model (e.g., ANN) until it reaches the first layer, and the gradients coming out of the first model layer are added to the 510 the header matrix. Next, the gradients are added to an accumulation matrix 512. If this is the first run with the input data set, the accumulation matrix may be all zeros. If this is the second run or epoch, the accumulation matrix may include the gradients associated with the first fun or epoch. If this is the second run, the gradients are added to the existing gradients in the accumulation matrix. In this manner, the accumulation matrix accumulates the gradients for each epoch or run of the dataset. When accumulating gradients in the accumulation matrix, the values of the initial header matrix (e.g., the Identity matrix) are removed. In other words, the header matrix prior to the forward propagation is subtracted from the header matrix after the back propagation in order to determine the gradient values, in matrix form, that are added to the accumulation matrix.

Next, the relative importance of the features is determined 514. In one example, each row of the accumulation matrix corresponds to one of the features of the input dataset. Summing (or averaging the sum) the values in each of the rows generates an importance value for each of the features. The relative importance can then be determined or inferred from these importance values.

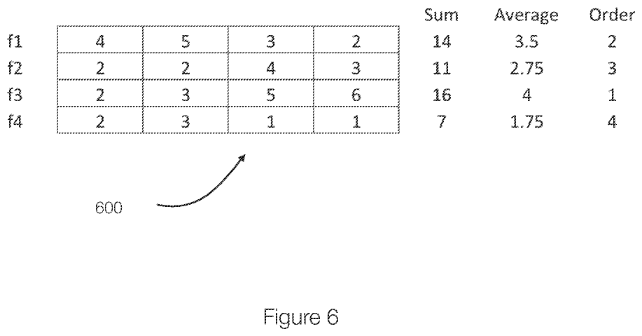

FIG. 6 discloses aspects of an accumulation matrix. Each row of the accumulation matrix 600 corresponds to a different feature. Row 1 corresponds to feature 1 (f1), row 2 corresponds to f2, row 3 corresponds to f3, and row 4 corresponds to f4. FIG. 6 illustrates that each row is averaged and/or summed. Both the average and/or the sum can be used to determine the relative importance of the features f1-f4. In this example, feature f3 is the most important feature and f4 is the least important feature.

The following is a discussion of aspects of example operating environments for various embodiments of the invention. This discussion is not intended to limit the scope of the invention, or the applicability of the embodiments, in any way.

At least some embodiments of the invention provide for the implementation of the disclosed functionality in existing backup platforms, examples of which include the Dell-EMC NetWorker and Avamar platforms and associated backup software, and storage environments such as the Dell-EMC DataDomain storage environment. In general, however, the scope of the invention is not limited to any particular data backup platform or data storage environment.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients, which may include machine learning models, may comprise physical machines, containers, or virtual machines (VM)

Particularly, devices in the operating environment may take the form of software, physical machines, containers, or VMs, or any combination of these, though no particular device implementation or configuration is required for any embodiment. Similarly, data protection system components such as databases, storage servers, storage volumes (LUNs), storage disks, replication services, backup servers, restore servers, backup clients, and restore clients, for example, may likewise take the form of software, physical machines or virtual machines (VM), though no particular component implementation is required for any embodiment.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing. The term data may also apply to datasets or features thereof used to train machine learning models.

It is noted that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

Following are some further example embodiments of the invention. These are presented only by way of example and are not intended to limit the scope of the invention in any way.
Embodiment 1. A method comprising: inputting a dataset that includes data items, wherein each data item includes features into a machine learning model, wherein a first layer of the machine learning model is a header matrix, performing a forward propagation of the features through the machine learning model, performing a back propagation of the features through the machine learning model, storing gradients generated by the back propagation in the header matrix, and determining a relative importance for each of the features based on the header matrix.
Embodiment 2. The method of embodiment 1, wherein the header matrix comprises an Identity matrix.
Embodiment 3. The method of embodiment 1 and/or 2, further comprising resetting the header matrix to an identity matrix prior to performing the forward propagation.
Embodiment 4. The method of embodiment 1, 2, and/or 3, further performing multiple epochs using the dataset, wherein gradients from each of the epochs are accumulated in an accumulation matrix and wherein the header matrix is reset prior to each of the multiple epochs.
Embodiment 5. The method of embodiment 1, 2, 3, and/or 4, wherein each row of the accumulation matrix corresponds to a feature of the dataset.
Embodiment 6. The method of embodiment 1, 2, 3, 4, and/or 5, further comprising summing or averaging the sum of each row of the dataset to generate an importance score for each of the rows, wherein the importance score corresponds to a relative importance of the corresponding feature.
Embodiment 7. The method of embodiment 1, 2, 3, 4, 5, and/or 6, further comprising identifying a least important feature and a most important feature based on the importance scores.
Embodiment 8. The method of embodiment 1, 2, 3, 4, 5, 6, and/or 7, further comprising subtracting an Identity matrix from the header matrix after the back propagation prior to accumulating the gradients in the accumulation matrix.
Embodiment 9. The method of embodiment 1, 2, 3, 4, 5, 6, 7, and/or 8, further comprising performing feature selection, machine learning introspection, dimensionality reduction, and/or drift detection based on the relative importance of each of the features.
Embodiment 10. A method for performing any of the operations, methods, or processes, or any portion of any of these, or any combination thereof, disclosed herein.
Embodiment 11. A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

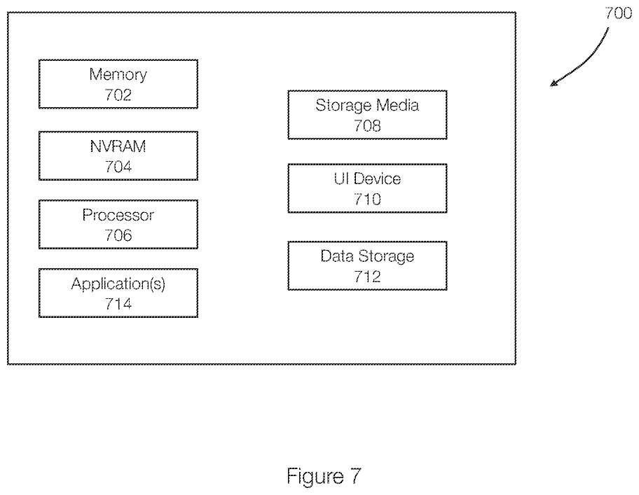

With reference briefly now to FIG. 7, any one or more of the entities disclosed, or implied, by the Figures, and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 7.

In the example of FIG. 7, the physical computing device 700 includes a memory 702 which may include one, some, or all, of random access memory (RAM), non-volatile memory (NVM) 704 such as NVRAM for example, read-only memory (ROM), and persistent memory, one or more hardware processors 706, non-transitory storage media 708, UI device 710, and data storage 712. One or more of the memory components 702 of the physical computing device 700 may take the form of solid-state device (SSD) storage. As well, one or more applications 714 may be provided that comprise instructions executable by one or more hardware processors 706 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
inputting a dataset that includes data items into a machine learning model, wherein each of the data items includes features, wherein a first layer of the machine learning model is a header matrix;
performing a forward propagation of the features through the machine learning model;
performing a back propagation of the features through the machine learning model;
storing gradients generated by the back propagation in the header matrix; and
determining a relative importance for each of the features based on the header matrix.

2. The method of claim 1, wherein the header matrix comprises an Identity matrix.

3. The method of claim 1, further comprising resetting the header matrix to an identity matrix prior to performing the forward propagation.

4. The method of claim 1, further performing multiple epochs using the dataset, wherein gradients from each of the epochs are accumulated in an accumulation matrix and wherein the header matrix is reset prior to each of the multiple epochs.

5. The method of claim 4, wherein each row of the accumulation matrix corresponds to a feature of the dataset.

6. The method of claim 5, further comprising summing or averaging the sum of each row of the dataset to generate an importance score for each of the rows, wherein the importance score corresponds to a relative importance of the corresponding feature.

7. The method of claim 6, further comprising identifying a least important feature and a most important feature based on the importance scores.

8. The method of claim 4, further comprising subtracting an Identity matrix from the header matrix after the back propagation prior to accumulating the gradients in the accumulation matrix.

9. The method of claim 1, further comprising performing feature selection, machine learning introspection, dimensionality reduction, and/or drift detection based on the relative importance of each of the features.

10. A non-transitory storage medium having stored therein instructions that are executable by one or more hardware processors to perform operations comprising:
inputting a dataset that includes data items into a machine learning model, wherein each of the data items includes features, wherein a first layer of the machine learning model is a header matrix;
performing a forward propagation of the features through the machine learning model;
performing a back propagation of the features through the machine learning model;
storing gradients generated by the back propagation in the header matrix; and
determining a relative importance for each of the features based on the header matrix.

11. The non-transitory storage medium of claim 10, wherein the header matrix comprises an Identity matrix.

12. The non-transitory storage medium of claim 10, further comprising resetting the header matrix to an identity matrix prior to performing the forward propagation.

13. The non-transitory storage medium of claim 10, further performing multiple epochs using the dataset, wherein gradients from each of the epochs are accumulated in an accumulation matrix and wherein the header matrix is reset prior to each of the multiple epochs.

14. The non-transitory storage medium of claim 13, wherein each row of the accumulation matrix corresponds to a feature of the dataset.

15. The non-transitory storage medium of claim 14, further comprising summing or averaging the sum of each row of the dataset to generate an importance score for each of the rows, wherein the importance score corresponds to a relative importance of the corresponding feature.

16. The non-transitory storage medium of claim 15, further comprising identifying a least important feature and a most important feature based on the importance scores.

17. The non-transitory storage medium of claim 13, further comprising subtracting an Identity matrix from the header matrix after the back propagation prior to accumulating the gradients in the accumulation matrix.

18. The non-transitory storage medium of claim 10, further comprising performing feature selection, machine learning introspection, dimensionality reduction, and/or drift detection based on the relative importance of each of the features.
